(19) United States
(12) Patent Application Publication
(10) Pub. No.: US 2024/0215011 A1
(43) Pub. Date: Jun. 27, 2024

(54) SIDELINK CO-CHANNEL CO-EXISTENCE VIA DYNAMIC SPECTRUM SHARING (DSS)

(71) Applicant: QUALCOMM Incorporated, San Diego, CA (US)

(72) Inventors: Peng CHENG, Beijing (CN); Qing LI, Princeton Junction, NJ (US); Hong CHENG, Basking Ridge, NJ (US); Tien Viet NGUYEN, Bridgewater, NJ (US); Huilin XU, Temecula, CA (US)

(21) Appl. No.: 18/556,575

(22) PCT Filed: Jul. 2, 2021
(86) PCT No.: PCT/CN2021/104161

§ 371 Date: Oct. 20, 2023

(51) Int. Cl. H04W 72/12; H04B 17/318; H04W 92/18

(52) U.S. Cl. CPC H04W 72/1215; H04B 17/328; H04W 92/18

(57) ABSTRACT

Certain aspects of the present disclosure are directed to techniques for configuring sidelink communication. One example method by a user-equipment (UE) generally includes monitoring for first control information scheduling a first sidelink (SL) transmission of a first radio access technology (RAT) on a resource pool, and taking one or more actions for scheduling of a second SL transmission of a second RAT based on the monitoring of the first control information, wherein the first RAT is different than the second RAT.

### INTRODUCTION

Aspects of the present disclosure relate to wireless communications, and more particularly, to techniques for configuring sidelink communication.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

Some aspects provide a method for wireless communication by a user-equipment (UE). The method generally includes monitoring for first control information scheduling a first sidelink (SL) transmission of a first radio access technology (RAT) on a first resource pool, and taking one or more actions for scheduling of a second SL transmission of a second RAT based on the monitoring of the first control information. Some aspects provide a method for wireless communication by a base station (BS). The method generally includes transmitting, to a UE, a configuration for the UE to monitor first control information for selection of one or more available resource pools for a first SL transmission of a first radio RAT, wherein the first control information schedules a second SL transmission of a second RAT, wherein the first RAT is different than the second RAT, receiving, from the UE, an indication of the one or more available resource pools, and transmitting an indication of a second resource pool for the first SL transmission, the second resource pool being selected from the one or more available resource pools.

Some aspects provide a method for wireless communication by a UE. The method generally includes selecting a resource pool for SL transmission of a first RAT, the resource pool being selected from candidate resource pools, the candidate resource pools being non-overlapping with other candidate resource pools configured for SL transmission of a second RAT, wherein the first RAT is different than the second RAT, and performing the SL transmission using the selected resource pool.

Some aspects provide a method for wireless communication by a BS. The method generally includes generating a message coordinating selection of a resource pool from first candidate resource pools, the resource pool being for SL transmission of a first RAT, wherein the first candidate resource pools is non-overlapping with second candidate resource pools configured for SL transmission of a second RAT, wherein the first RAT is different than the second RAT, and transmitting the message to a UE.

Some aspects provide an apparatus for wireless communication by a UE. The apparatus generally includes a memory and one or more processors coupled to the memory, the memory and the one or more processors being configured to monitor for first control information scheduling a first SL transmission of a first RAT on a first resource pool, and take one or more actions for scheduling of a second SL transmission of a second RAT based on the monitoring of the first control information, wherein the first RAT is different than the second RAT.

Some aspects provide an apparatus for wireless communication by a BS. The apparatus generally includes a memory and one or more processors coupled to the memory, the memory and the one or more processors being configured to transmit, to a UE, a configuration for the UE to monitor first control information for selection of one or more available resource pools for a first SL transmission of a first RAT, wherein the first control information schedules a second SL transmission of a second RAT, wherein the first RAT is different than the second RAT, receive, from the UE, an indication of the one or more available resource pools, and transmit an indication of a second resource pool for the first SL transmission, the second resource pool being selected from the one or more available resource pools.

Some aspects provide an apparatus for wireless communication by a UE. The apparatus generally includes a memory and one or more processors coupled to the memory, the memory and the one or more processors being configured to select a resource pool for SL transmission of a first RAT, the resource pool being selected from candidate resource pools, the candidate resource pools being non-overlapping with other candidate resource pools configured for SL transmission of a second RAT, wherein the first RAT is different than the second RAT, and perform the SL transmission using the selected resource pool.

Some aspects provide an apparatus for wireless communication by a BS. The apparatus generally includes a memory and one or more processors coupled to the memory, the memory and the one or more processors being configured to generate a message coordinating selection of a resource pool from first candidate resource pools, the resource pool being for SL transmission of a first RAT, wherein the first candidate resource pools is non-overlapping with second candidate resource pools configured for SL transmission of a second RAT, wherein the first RAT is different than the second RAT, and transmit the message to a UE.

Some aspects provide an apparatus for wireless communication by a UE. The apparatus generally includes means for monitoring for first control information scheduling a first SL transmission of a first RAT on a first resource pool, and means for taking one or more actions for scheduling of a second SL transmission of a second RAT based on the monitoring of the first control information, wherein the first RAT is different than the second RAT.

Some aspects provide an apparatus for wireless communication by a BS. The apparatus generally includes means for transmitting, to a UE, a configuration for the UE to monitor first control information for selection of one or more available resource pools for a first SL transmission of a first RAT, wherein the first control information schedules a second SL transmission of a second RAT, wherein the first RAT is different than the second RAT, means for receiving, from the UE, an indication of the one or more available resource pools, and means for transmitting an indication of a second resource pool for the first SL transmission, the second resource pool being selected from the one or more available resource pools.

One aspects provides an apparatus for wireless communication by a UE. The apparatus generally includes means for selecting a resource pool for SL transmission of a first RAT, the resource pool being selected from candidate resource pools, the candidate resource pools being non-overlapping with other candidate resource pools configured for SL transmission of a second RAT, wherein the first RAT is different than the second RAT, and means for performing the SL transmission using the selected resource pool.

Some aspects provide an apparatus for wireless communication by a BS. The apparatus generally includes means for generating a message coordinating selection of a resource pool from first candidate resource pools, the resource pool being for SL transmission of a first RAT, wherein the first candidate resource pools is non-overlapping with second candidate resource pools configured for SL transmission of a second RAT, wherein the first RAT is different than the second RAT, and means for transmitting the message to a UE.

Some aspects provide a non-transitory computer-readable medium comprising executable instructions that, when executed by one or more processors of a UE, cause the UE to monitor for first control information scheduling a first SL transmission of a first RAT on a first resource pool, and take one or more actions for scheduling of a second SL transmission of a second RAT based on the monitoring of the first control information, wherein the first RAT is different than the second RAT.

Some aspects provide a non-transitory computer-readable medium comprising executable instructions that, when executed by one or more processors of a BS, cause the BS to transmit, to a UE, a configuration for the UE to monitor first control information for selection of one or more available resource pools for a first SL transmission of a first RAT, wherein the first control information schedules a second SL transmission of a second RAT, wherein the first RAT is different than the second RAT, receive, from the UE, an indication of the one or more available resource pools, and transmit an indication of a second resource pool for the first SL transmission, the second resource pool being selected from the one or more available resource pools.

Some aspects provide a non-transitory computer-readable medium comprising executable instructions that, when executed by one or more processors of a UE, cause the UE to select a resource pool for SL transmission of a first RAT, the resource pool being selected from candidate resource pools, the candidate resource pools being non-overlapping with other candidate resource pools configured for SL transmission of a second RAT, wherein the first RAT is different than the second RAT, and perform the SL transmission using the selected resource pool.

Some aspects provide a non-transitory computer-readable medium comprising executable instructions that, when executed by one or more processors of a BS, cause the BS to generate a message coordinating selection of a resource pool from first candidate resource pools, the resource pool being for SL transmission of a first RAT, wherein the first candidate resource pools is non-overlapping with second candidate resource pools configured for SL transmission of a second RAT, wherein the first RAT is different than the second RAT, and transmit the message to a UE.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example base station and user equipment.

FIGS. 3A-3D depict various example aspects of data structures for a wireless communication network.

FIGS. 3E-3F depict sidelink communication systems.

FIG. 4A is a diagram showing examples for downlink (DL) dynamic spectrum sharing (DSS) implementations.

FIG. 4B is a diagram showing examples for uplink (UL) DSS sharing implementations.

FIG. 4C an example cross-carrier scheduling technique.

FIGS. 5A, 5B, 5C, and 5D illustrate new radio (NR) and long-term evolution (LTE) implemented using different mode of operation.

FIG. 6 illustrates an example communication system with UEs operating in LTE mode 3 and NR mode 1.

FIGS. 7A and 7B illustrate example communication system and signaling aspects for LTE mode 4 and NR mode 2, in accordance with certain aspects of the present disclosure.

FIG. 8 illustrates an example communication system for LTE mode 4 and NR mode 1, in accordance with certain aspects of the present disclosure.

FIG. 9A illustrates an example communication system for LTE mode 3 and NR mode 2, in accordance with certain aspects of the present disclosure.

FIG. 9B illustrates is a call flow diagram illustrating example operation for sidelink scheduling, in accordance with certain aspects of the present disclosure.

FIG. 10 is a flow diagram illustrating example operations for wireless communication by a BS, in accordance with certain aspects of the present disclosure.

FIG. 11 is a flow diagram illustrating example operations for wireless communication by a user equipment (UE), in accordance with certain aspects of the present disclosure.

FIG. 12 illustrates candidate resource pools for LTE and NR, in accordance with certain aspects of the present disclosure.

FIG. 13 is a flow diagram illustrating example operations for wireless communication by a BS, in accordance with certain aspects of the present disclosure.

FIG. 14 is a flow diagram illustrating example operations for wireless communication by a UE, in accordance with certain aspects of the present disclosure.

FIGS. 15 and 16 depict aspects of example communications devices.

### DETAILED DESCRIPTION

Aspects of the present disclosure provide apparatuses, methods, processing systems, and computer-readable mediums for sidelink configuration that allow co-channel co-existence of different radio access technologies (RATs). Dynamic spectrum sharing (DSS) permits RATs to coexist on a channel, allowing network operators a smooth transition from the one RAT to another, such as from long-term evolution (LTE) to new radio (NR). For example, in some aspects, a first RAT may share a frequency channel with a second RAT, meaning that devices using the first RAT and devices using the second RAT may both communicate over the frequency channel. Communication for the first RAT coexisting on a channel with communication for a second RAT may result in interference between the communications of the first and second RATs. Therefore, one or more aspects of the present disclosure provide apparatus and techniques that facilitate DSS while taking measures to reduce interference between communications for the different RATs.

In some aspects of the present disclosure, a UE using the first RAT may monitor control information addressed to other UEs using the second RAT, and may cancel or preclude resource reservation on the first RAT on resources (e.g., time-frequency resources) scheduled by the control information for communication using the second RAT in an attempt to reduce possible interference with the other UEs of the second RAT. For instance, according to one example, if a new radio (NR) UE has scheduled a transmission on a resource, but detects control information for another LTE UE that schedules a transmission on the same resource, the NR UE may take one or more actions to cancel the scheduled transmission on the resource to avoid interfering with the other LTE UE.

In some aspects, co-channel co-existence by the UE with other UEs using the different RATs may be implemented by configuring resources for communication using different RATs on non-overlapping resources. In other words, at least one BS may provide a list of candidate resources to be selected from for communication on LTE and a list of candidate resources to be selected from for communication on NR. The candidate resources for communication on LTE may be non-overlapping with the candidate resources for communication on NR, effectively reducing interference between the communications on NR and LTE.

The aspects described herein increase resource utilization by allowing different RATs to share a frequency channel while taking measures to reduce interference between communications for the different RATs. For example, with an NR UE monitoring for control information to or from other LTE UEs, the NR UE can schedule resources for NR sidelink communication with more information regarding scheduling activities of the LTE UEs. As a result, the NR UE may schedule the resources for NR communication in a manner as to reduce interference with LTE communications. For example, the NR UE may select resources for communication that is not scheduled by the LTE UEs for LTE communication.

### Introduction to Wireless Communication Networks

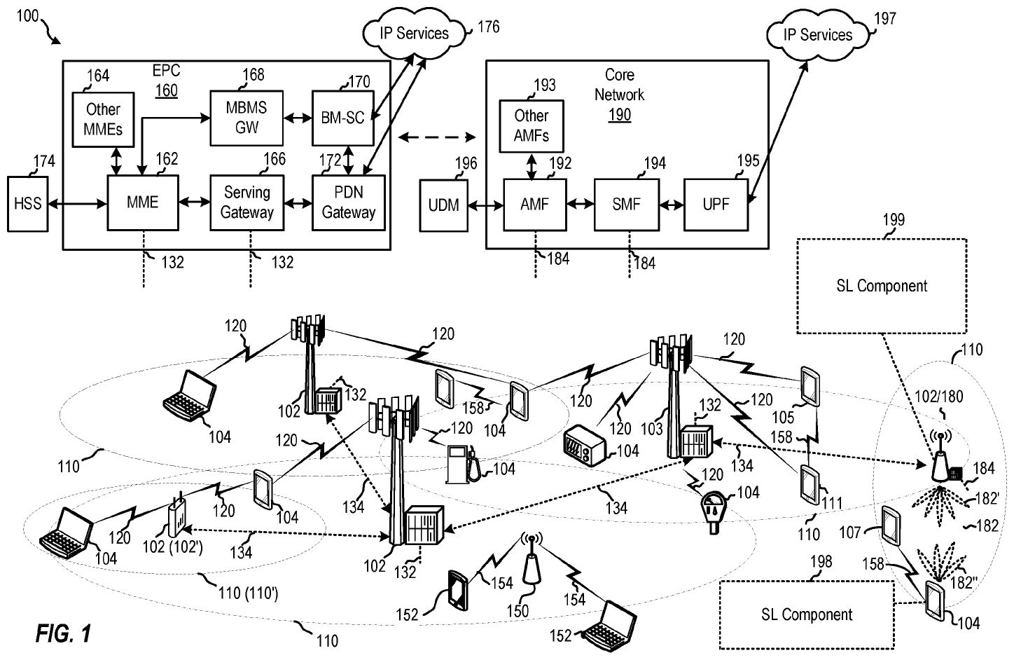

FIG. 1 depicts an example of a wireless communications system 100, in which aspects described herein may be implemented.

Generally, wireless communications system 100 includes base stations (BSs) 102 (which may also be referred to herein as access node (AN) 102), user equipments (UEs) 104, an Evolved Packet Core (EPC) 160, and core network 190 (e.g., a 5G Core (5GC)), which interoperate to provide wireless communications services.

Base stations 102 may provide an access point to the EPC 160 and/or core network 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, Node B, eNB, an access point, a base transceiver station, a radio base station, a radio transceiver, or a transceiver function, or a transmit reception point (TRP) in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Wireless communication network 100 includes a SL component 199, which may configure resources for SL communication to facilitate co-channel co-existence by different RATs. For example, UE 104 having the SL component 198 may be associated with a first RAT, and the SL component 198 may facilitate SL communication with UE 107 in a manner that avoids interfering with other UEs associated with a second RAT. For example, UE 105 and UE 111 (e.g., served by BS 103) may be associated with the second RAT. Thus, the SL component 198 may take action to avoid interfering with communications of UE 105 and UE 111. Wireless network 100 further includes a SL component 198, which may configure resources for SL communication to facilitate co-channel co-existence by different RATs.

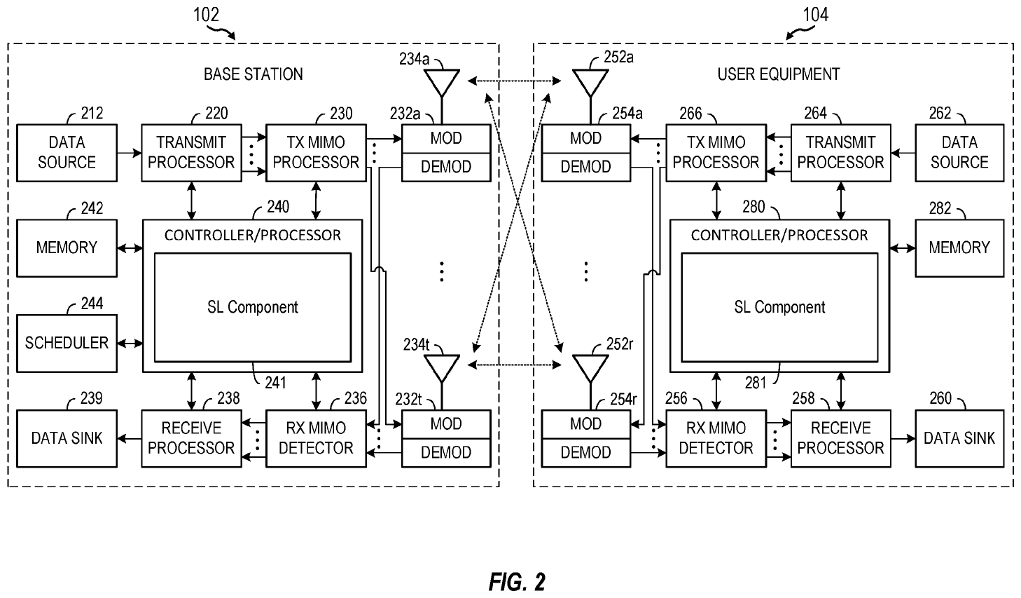

FIG. 2 depicts aspects of an example base station (BS) 102 and a user equipment (UE) 104.

Generally, base station 102 includes various processors (e.g., 220, 230, 238, and 240), antennas 234a-t (collectively antennas 234), transceivers 232a-t (collectively transceivers 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes a SL component 241, which may be representative of SL component 199 of FIG. 1. Notably, while depicted as an aspect of controller/processor 240, a SL component 241 may be implemented additionally or alternatively in various other aspects of base station 102 in other implementations.

Generally, user equipment 104 includes various processors (e.g., 258, 264, 266, and 280), antennas 252a-r (collectively antennas 252), transceivers 254a-r (collectively transceivers 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes SL component 281, which may be representative of SL component 198 of FIG. 1. Notably, while depicted as an aspect of controller/processor 280, SL component 281 may be implemented additionally or alternatively in various other aspects of user equipment 104 in other implementations.

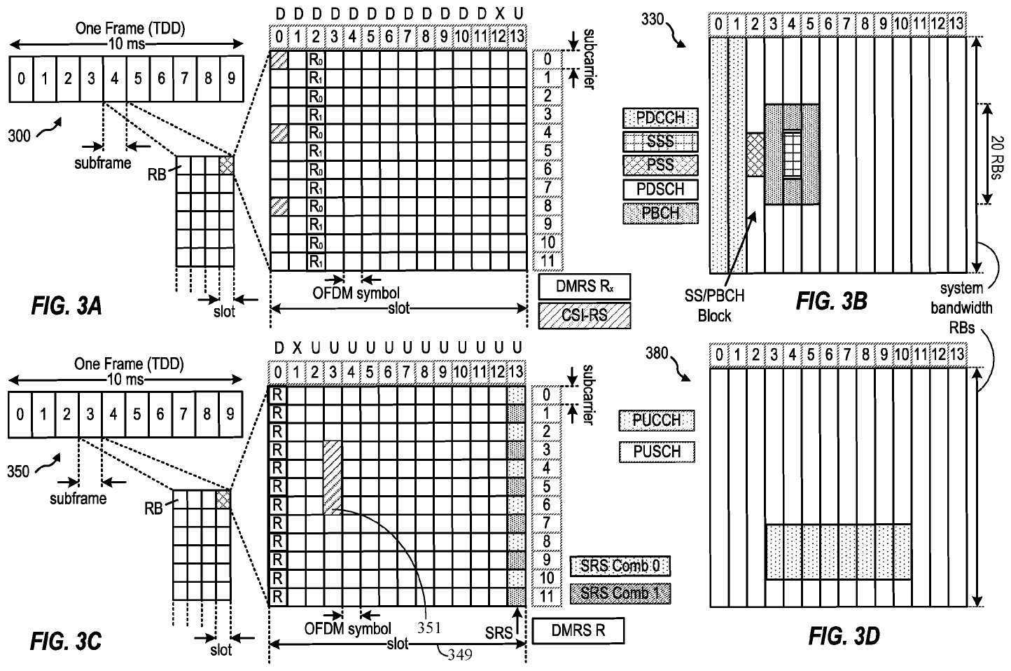

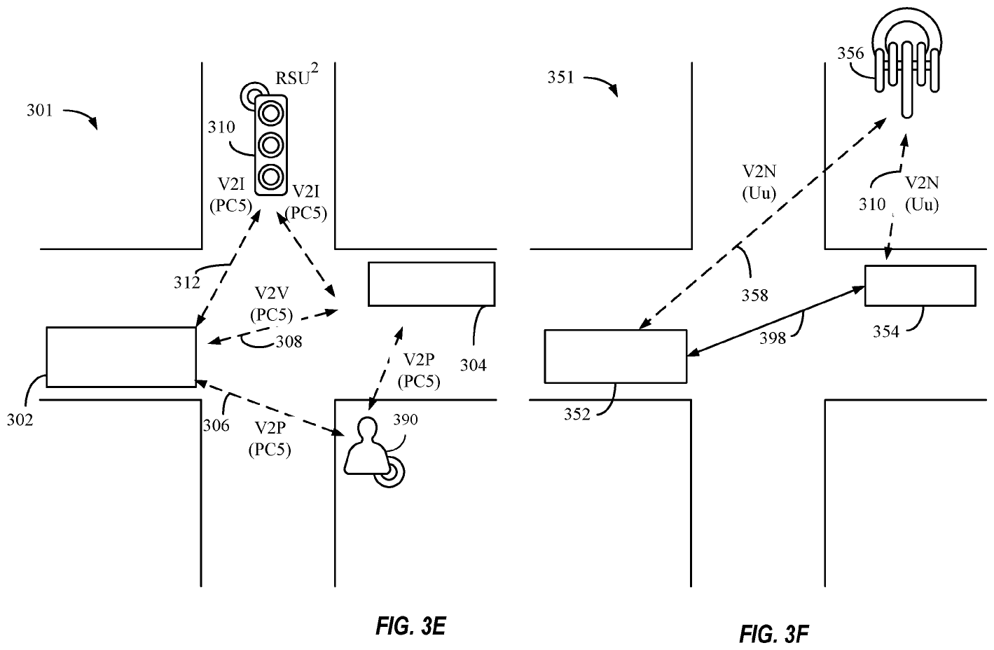

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe. In some aspects, UEs may be configured to communicate (e.g., SL communications) using the frame format described with respect to diagrams 300, 330, 350, 380. For example, as shown in FIG. 3C, a portion of slot 349 may be used for SL communication 351. The SL communication 351 may be used to communicate sidelink control information (SCI) from one UE to another UE. A radio frame (e.g., as shown in diagram 300) may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on subcarrier spacing (SCS), during which SL communication may occur. As discussed, in certain aspects, a device may measure channel conditions in one or more SL frequency channels for a time period shorter than one slot to determine whether to use the one or more SL frequency channels for SL communications. Further discussions regarding FIG. 1, FIG. 2, and FIGS. 3A-3D are provided later in this disclosure.

### Introduction to Sidelink

FIGS. 3E and 3F show diagrammatic representations of example vehicle to everything (V2X) systems in accordance with some aspects of the present disclosure. For example, the UEs shown in FIGS. 3E and 3F may communicate via sidelink channels and may perform sidelink channel state information (CSI) reporting as described herein.

The V2X systems, provided in FIGS. 3E and 3F provide two sidelink operating modes. A first sidelink operating mode, shown by way of example in FIG. 3E, involves direct communications (for example, also referred to as side link communications) between participants in proximity to one another in a local area. The first sidelink operating mode may be referred to as NR mode 2 when using NR technology, or may be referred to as LTE mode 4 when using LTE technology. In NR mode 2 or LTE mode 4, a UE may autonomously configure resources for SL communication (e.g., without management by a BS). A second sidelink operating mode, shown by way of example in FIG. 3F, involves communications through a network, which may be implemented over a Uu interface (for example, a wireless communication interface between a radio access network (RAN) and a UE). As illustrated, UEs 352, 354 may communicate with each other using a sidelink (SL) 398. The second sidelink operating mode may be referred to as NR mode 1 when using NR technology, or may be referred to as LTE mode 3 when using LTE technology. In NR mode 1 and LTE mode 3, the SL communication of a UE (e.g., UE 352 or UE 354) may be managed (e.g., scheduled) by a BS (e.g., network entity 356).

Referring to FIG. 3E, a V2X system 301 (for example, including vehicle to vehicle (V2V) communications) is illustrated with two UEs 302, 304 (e.g., vehicles). The first transmission mode allows for direct communication between different participants in a given geographic location. As illustrated, a vehicle can have a wireless communication link 306 with an individual 390 (V2P) (for example, via a UE) through an interface such as a PC5 interface. Communications between the UEs 302 and 304 may also occur through an interface 308 (e.g., a PC5 interface). In a like manner, communication may occur from a UE 302 to other highway components (for example, highway component 310), such as a traffic signal or sign (V2I) through an interface 312 (e.g., PC5 interface). With respect to each communication link illustrated in FIG. 3E, two-way communication may take place between wireless nodes, therefore each wireless node may be a transmitter and a receiver of information. The V2X system 301 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 3F shows a V2X system 351 for communication between a UE 352 (e.g., vehicle) and a UE 354 (e.g., vehicle) through a network entity 356. These network communications may occur through discrete nodes, such as a base station (for example, an eNB or gNB), that sends and receives information to and from (for example, relays information between) UEs 352, 354. The network communications through vehicle to network (V2N) links (e.g., Uu links 358 and 310) may be used, for example, for long range communications between vehicles, such as for communicating the presence of a car accident a distance ahead along a road or highway. Other types of communications may be sent by the node to vehicles, such as traffic flow conditions, road hazard warnings, environmental/weather reports, and service station availability, among other examples. Such data can be obtained from cloud-based sharing services.

In some circumstances, two or more subordinate entities (for example, UEs) may communicate with each other using sidelink signals. As described above, V2V and V2X communications are examples of communications that may be transmitted via a sidelink. Other applications of sidelink communications may include public safety or service announcement communications, communications for proximity services, communications for UE-to-network relaying, device-to-device (D2D) communications, Internet of Everything (IoE) communications, Internet of Things (IOT) communications, mission-critical mesh communications, among other suitable applications. Generally, a sidelink may refer to a direct link between one subordinate entity (for example, UE1) and another subordinate entity (for example, UE2). As such, a sidelink may be used to transmit and receive a communication (also referred to herein as a “sidelink signal”) without relaying the communication through a scheduling entity (for example, a BS), even though the scheduling entity may be utilized for scheduling or control purposes in some scenarios. In some examples, a sidelink signal may be communicated using a licensed spectrum (unlike wireless local area networks, which typically use an unlicensed spectrum). While FIGS. 3E and 3F describe techniques for sidelink communication by referring to vehicles, the aspects described herein are applicable to any UEs capable of sidelink communication.

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions. The PSFCH may carry feedback such as channel state information (CSI) related to a sidelink channel quality.

### Introduction on Dynamic Spectrum Sharing

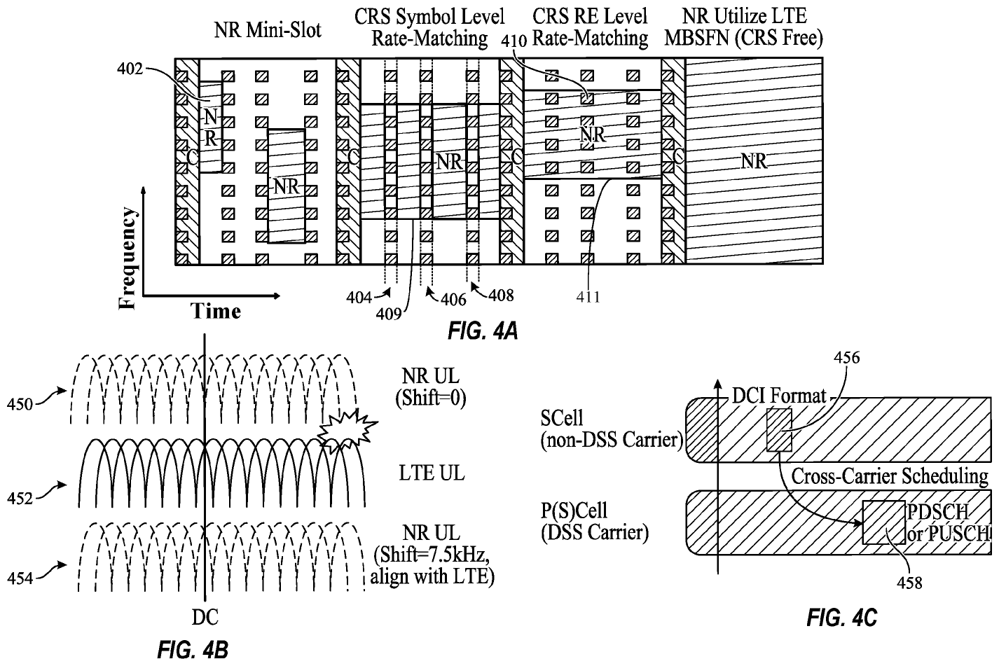

FIG. 4A is a diagram showing examples for downlink (DL) dynamic spectrum sharing (DSS) implementations, according to one or more aspects of the present disclosure. New radio (NR) has specified different DSS solutions for long-term evolution (LTE) and NR Uu link co-channel existence. DSS is a mechanism that allows deployment of different radio access technologies (RATs) (e.g., NR and LTE) in the same band with dynamic allocation of resources based on user demand. To implement DSS, NR may use one or more mini-slots (e.g., mini-slot 402) in the LTE spectrum, as shown. A slot is typical unit for transmission used by a scheduling mechanism. NR allows transmission to start at any symbol and to last only as many symbols as required for communication, which may be referred to as a mini-slot transmission.

Some DL DSS solutions may be implemented using LTE cell reference signal (CRS) rate matching. In some cases, DSS may be implemented using LTE CRS rate matching which may use the symbol level rate matching (e.g., a UE may rate match around symbols 404, 406, 408 when decoding an NR transmission 409) or resource element (RE) level rate matching (e.g., a UE may rate match around specific REs, such as RE 410 when decoding an NR transmission 411), as shown in FIG. 4A. Rate matching around a symbol generally refers to skipping decoding of the symbol. NR general rate matching around LTE physical broadcast channel (PBCH) (e.g., LTE CRS) and synchronization signals may be used in some cases to implement DSS. In some implementations, NR PDCCH may be configured to avoid LTE physical downlink control channel (PDCCH). NR physical downlink shared channel (PDSCH) demodulation reference signal (DMRS) may be transmitted in an LTE normal subframe (e.g., additional DMRS avoids CRS). In some cases, DSS may be implemented using LTE multicast-broadcast single-frequency network (MBSFN), as shown.

FIG. 4B is a diagram showing examples for uplink (UL) DSS sharing implementations, according to aspects of the present disclosure. UL DSS solutions may include UL subcarrier alignment. For example, radio resource control (RRC) signalling may be used to configure whether to apply a 7.5 KHz shift to subcarriers 450 for NR, such that the subcarriers for NR (e.g., shifted subcarriers 454) are aligned with the subcarriers 452 for LTE to reduce interference, as shown. In other words, the frequency band associated with subcarriers 450 may be increased (or decreased) by 7.5 KHz to align the subcarriers 450 with subcarriers 452.

FIG. 4C illustrates an example cross-carrier scheduling technique. As shown, the secondary cell (SCell) in a non-DSS carrier may be used to schedule a PDSCH or physical uplink shared channel (PUSCH) of a secondary primary cell (SPCell) in a DSS carrier. For example, downlink control information (DCI) 456 on the SCell may be used to schedule PDSCH or PUSCH 458 on the SPCell, as shown. Cross-carrier scheduling reduces signaling overhead by allowing DCI on one cell (e.g., SCell) to schedule data PDSCH or PUSCH on another cell (e.g., SPCell).

### Example Techniques for Co-Channel Co-Existence in Different Operating Modes

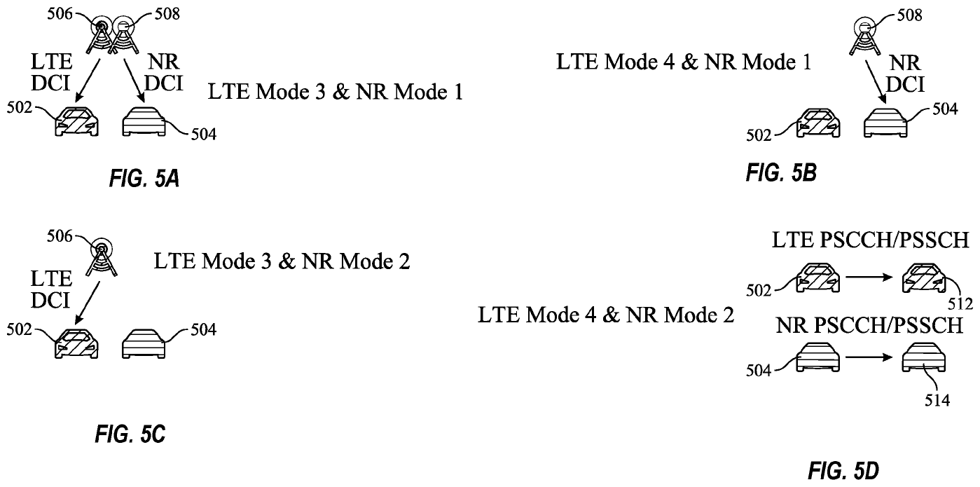

FIGS. 5A, 5B, 5C, and 5D illustrate NR and LTE implemented using different modes of operation, referred to herein as NR mode 1, NR mode 2, LTE mode 3, and LTE mode 4. NR mode 1 and LTE mode 3 are similar modes of operation, where NR mode 1 refers to a mode of operation for NR communication and LTE mode 3 refers to a mode of operation for LTE communication. Moreover, NR mode 2 and LTE mode 4 are similar modes of operation, where NR mode 2 refers to a mode of operation for NR communication and LTE mode 4 refers to a mode of operation for LTE communication. Depending on the mode of operation, a UE may be managed by a BS for SL resource scheduling, or autonomously configure resources for SL communication.

As shown, in NR mode 1 or LTE mode 3 (e.g., shown in FIG. 5A), the SL communication of a UE (e.g., LTE UE 502 or NR UE 504) may be managed (e.g., scheduled) by a BS (e.g., LTE BS 506 or NR BS 508). In NR mode 2 or LTE mode 4 (e.g., shown in FIG. 5D), the UE (e.g., LTE UE 502 or NR UE 504) may autonomously configure resources for SL communication (e.g., for communication with LTE UE 512 or NR UE 514). In some cases, an NR UE 504 may operate in mode 2, while an LTE UE 502 may operate in mode 3 (e.g., is managed by the BS 506), as shown in FIG. 5C). In some cases, the NR UE 504 may operate in mode 1 (e.g., is managed by the BS 508), while the LTE UE may operate in mode 4, as shown in FIG. 5B. Certain aspects of the present disclosure provide signaling protocols for the different modes of operation described with respect to FIG. 5 that allow for co-channel co-existence.

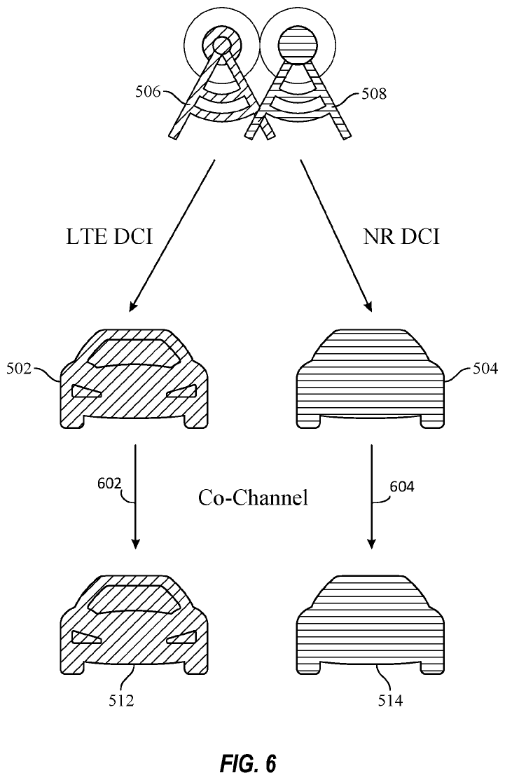

FIG. 6 illustrates an example communication system with UEs operating in LTE mode 3 and NR mode 1. As shown, UE 502 may communicate with UE 512 using SL channel 602 and UE 504 may communicate with UE 514 using SL channel 604. In such a scenario, to facilitate co-channel co-existence of NR and LTE UEs 502, 504, a 7.5 KHz frequency shift may be implemented for NR sidelink. The network (NW) may be aware of both LTE and NR sidelink transmissions, and may use radio resource control (RRC) signaling to configure whether to apply the 7.5 KHz shift for NR sidelink. When the 7.5 KHz frequency shift is implemented, subcarriers for NR may be aligned with the subcarrier for LTE to reduce interference, allowing for the co-channel co-existence, as described with respect to FIG. 4B. While 7.5 KHz is shown as an example, any suitable frequency shift may be implemented to facilitate co-channel co-existence.

In some aspects of the present disclosure, spectrum sharing between a first radio access technology (RAT) such as NR and a second RAT such as LTE by configuring a UE for the first RAT to monitor control information associated with the second RAT. Based on the monitoring of the control information, the UE may select one or more resource pools for communication using the first RAT in a manner as to avoid interference with the communication for the second RAT.

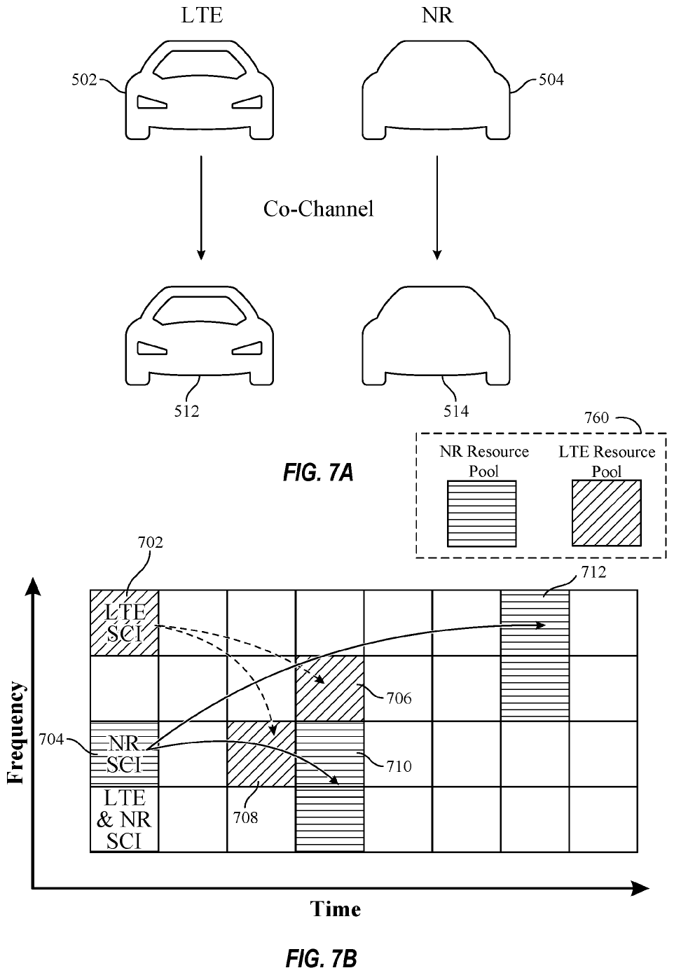

FIGS. 7A and 7B illustrate an example communication system and signaling aspects for LTE mode 4 and NR mode 2, in accordance with certain aspects of the present disclosure. NR UE 504 may communicate using a frequency band allocated for communication by LTE UE 502. Thus, the NR UE 504 may take one or more actions to avoid interfering with the communication of the NR UE 504. For example, the NR UE 504 may monitor control information for LTE and select resources for NR communication based on the monitoring so as to avoid interference with the LTE communications. As shown in FIG. 7B, an NR UE may monitor SCIs for LTE and NR for resource reservation. One or more of the blocks shown in FIG. 7B represent a resource pool for NR or LTE, as shown in legend 760. The LTE and NR resource pools may be configured (or preconfigured) with at least partial overlapping, where some resources used for LTE communication may overlap with resources used for NR communication, meaning some resources may be available for use for LTE and NR communications. The SL NR UE (e.g., UE 504) may monitor both LTE and NR SCI to avoid interfering with LTE or NR communications of other UEs. For example, the SL NR UE 504 may monitor the configured NR resource pool (e.g., monitor for NR SCI 704), and the resource pool on which an LTE SCI (e.g., transmitted by UE 502 and addressed to UE 512) is detected may be used to preclude a resource for reservation that would have otherwise overlapped and caused interference with communication of LTE UEs. In other words, reserving resource pool 706 for NR communication may be precluded due to the LTE SCI 702 scheduling resource for LTE communication in resource pool 706. As one example, the UE 504 may parse SCI (e.g., SCI 702 for LTE or SCI 704 for NR) to determine the resource pool being scheduled by the SCI. SCI generally includes control information used to configure a sidelink communication. SCI 702 for LTE may schedule resource pools 706, 708 for transmission and SCI 704 may schedule resource pools 710, 712 for transmission. The resource pool(s) reserved by SCI for LTE or NR may be precluded from consideration when the NR UE 504 is reserving resources. In other words, the NR UE 504 may forgo reserving resource pools 706, 708, 710, 712 when reserving resources (e.g., scheduling resources using SCI) for SL communication.

In some aspects, the SL UE 504 may apply a lower reference signal receive power (RSRP) threshold for LTE SCI detected (e.g., treated as high priority transmission) as compared to a RSRP threshold applied for NR SCI detection. In other words, the UE 504 may detect an SCI (e.g., LTE SCI 702) when a measured RSRP associated with the SCI is greater than a configured RSRP threshold. In other words, the UE may measure an RSRP associated with the SCI and compare the RSRP to the configured RSRP threshold. If the RSRP is greater than the RSRP threshold, the SCI 702 may be detected and processed. Therefore, by setting a lower RSRP threshold for detection of the LTE SCI 702, the UE more easily detects the LTE SCI, allowing the UE to take measures to reduce interference with the LTE communication.

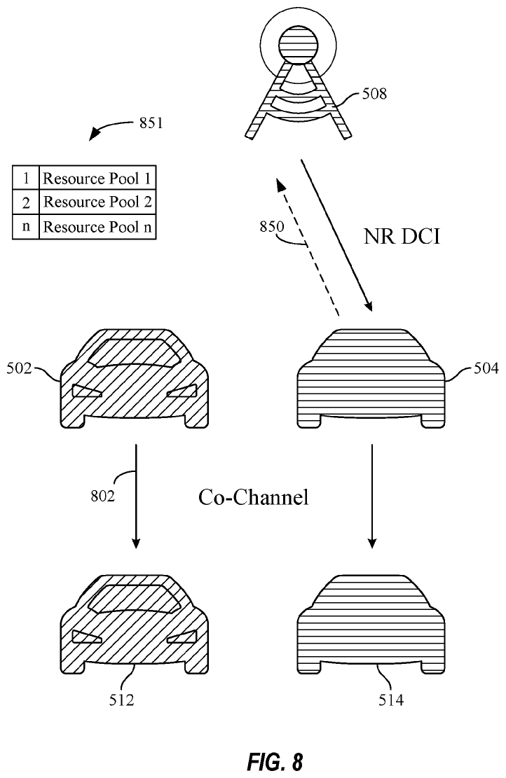

FIG. 8 illustrates an example communication system for LTE mode 4 and NR mode 1, in accordance with certain aspects of the present disclosure. In some aspects, the NR SL UE 504 may perform periodic NR resource pool monitoring for both LTE and NR SCI, and report a list of available resource pools 850 to the BS 508. For example, the NR UE 504 may monitor for LTE SCI (e.g., SCI 802 from UE 502 to UE 504), based on which the NR UE 504 may determine a list of available resource pools which may be configured by the BS 508. The NR UE 504 may transmit the list of available resource pools to the BS 508, allowing the BS 508 to configure SL communication by selecting a resource pool from the list reported by the NR UE 504. The monitoring for determining the list of available resources and reporting of the list of available resources may occur periodically during monitoring windows. The periodicity and duration of SCI monitoring window may be configured by the BS 508 via RRC signaling. In some aspects, the available resource pool list can be transmitted to the BS 508 via a sidelinkUEinformationNR message. In some aspects, the available resource pool list can be transmitted to the BS 508 via a SL medium access control (MAC)-control element (CE) with a bitmap 851 where each bit of the bitmap is mapped to a resource pool that is configured via RRC signaling. For example, the bitmap 851 may include n bits, n being an integer greater than 1. Each bit may be mapped to one of resource pools 1-n, as shown.

In some aspects, the NR UE 504 operating in NR mode 1 may transmit, to the BS 508, a request to change a mode of operation of the UE 504 allowing the UE 504 to schedule SL resources independently from the BS. In other words, the SL NR UE 504 may request to use NR mode 2 via a sidelinkUEinformationNR message. The BS 508 may respond allowing the transition to NR mode 2, at which point, the NR UE 504 may operate using the techniques described herein with respect to FIG. 7.

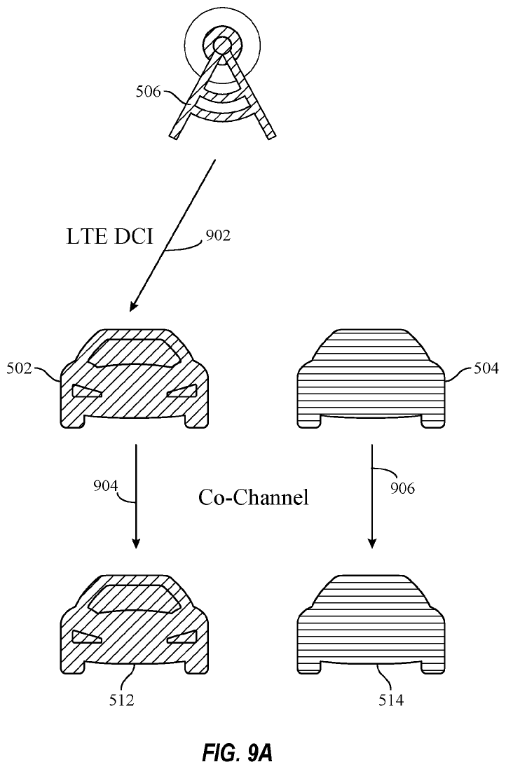

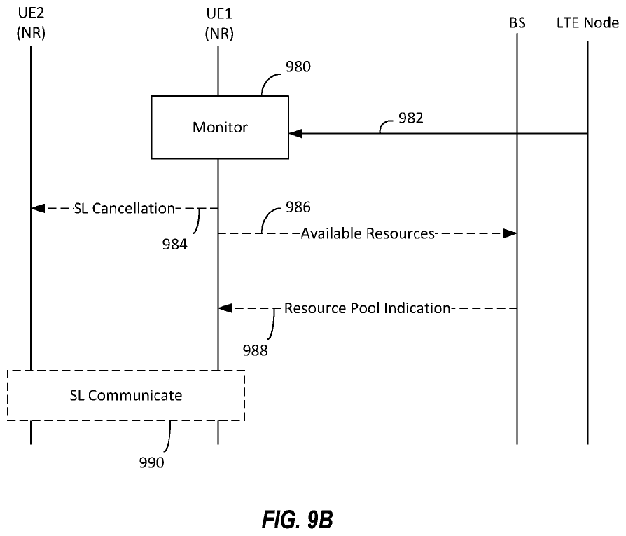

FIG. 9A illustrates an example communication system for LTE mode 3 and NR mode 2, in accordance with certain aspects of the present disclosure. An NR UE 504 may cancel its NR resource pool reservation with LTE sidelink transmission detected based on LTE SCI monitoring. In other words, the NR UE 504 may monitor SCI or DCI for LTE (e.g., a DCI 902 from BS 506 to LTE UE 502, or SCI 904 from LTE UE 502 to LTE UE 512). Once an SCI 904 or DCI 902 for LTE is detected, the NR UE 504 may parse the SCI 904 or DCI 902 and determine the resource pool scheduled by the SCI 904 or DCI 902. If the resource pool scheduled overlaps with a reserved resource for NR, the UE 504 may cancel the resource reservation. For example, the NR UE 504 may transmit SCI 906 to NR UE 514 cancelling a scheduled resource pool for NR communication to reduce interference to the LTE UE 502.

In one example, the LTE sidelink transmission may be treated as high priority by using a lower RSRP threshold for LTE SCI or DCI detection. The NR UE triggers the resource re-selection upon detection of its resource pool occupied by LTE SL transmission.

FIG. 9B is a call flow diagram illustrating example operations for sidelink scheduling, in accordance with certain aspects of the present disclosure. As shown, at block 980, NR UE1 may monitor for control information 982 (e.g., SCI or DCI) for LTE. The control information 982 may be from an LTE node, such as an LTE UE or a BS scheduling communications for the LTE UE. As described, once an SCI or DCI for LTE is detected, NR UE1 may parse the SCI or DCI and determine the resource pool scheduled by the SCI or DCI. If the resource pool scheduled overlaps with a reserved resource for NR, the NR UE1 may cancel the resource reservation. For example, the NR UE1 may have scheduled a transmission using resource pool 706. Upon detection that LTE SCI 702 has scheduled a transmission using resource pool 706, the NR UE1 may take action to cancel the scheduled transmission on resource pool 706 to avoid interfering with the LTE UE. In some aspects, the NR UE1 may transmit SCI 984 to NR UE2 to cancel the scheduled transmission on the resource pool (e.g., resource pool 706) for NR communication to reduce interference.

In some aspects, once an SCI or DCI for LTE is detected, the NR UE1 may determine a list of available resource pools which may be configured by the BS. The NR UE1 may transmit the list of available resource pools 986 to the BS, allowing the BS to configure SL communication by selecting a resource pool 988 from the list reported by the NR UE1 and indicate the resource pool 988 to the NR UE1. The indicated resource pool 988 may be used for SL communication at block 990. While some examples provided herein are described with respect to NR and LTE to facilitate understanding, the aspects described herein may be applied for any suitable RATs.

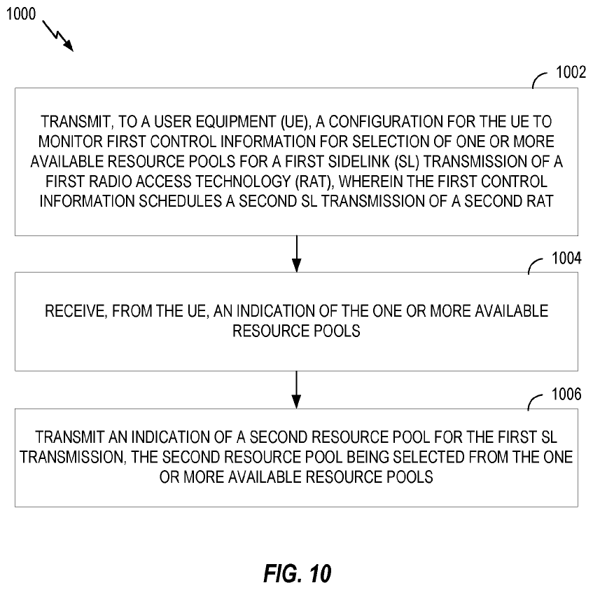

FIG. 10 is a flow diagram illustrating example operations 1000 for wireless communication, in accordance with certain aspects of the present disclosure. The operations 1000 may be performed, for example, by a network entity and/or a BS (e.g., the BS 110a in the wireless communication network 100). The operations 1000 may be implemented as software components that are executed and run on one or more processors (e.g., controller/processor 240 of FIG. 2). Further, the transmission and reception of signals by the BS in operations 1000 may be enabled, for example, by one or more antennas (e.g., antennas 234 of FIG. 2). In certain aspects, the BS's transmission and/or reception of signals may be implemented via a bus interface of one or more processors (e.g., controller/processor 240) obtaining and/or outputting signals. In some aspects, the operations 1000 may be executed based on instructions stored in memory, such as memory 242.

The operations 1000 may begin, at block 1002, with the BS transmitting, to a UE (e.g., UE 504), a configuration for the UE to monitor first control information (e.g., LTE SCI 702) for selection of one or more available resource pools for a first SL transmission of a first RAT (e.g., NR). The first control information may schedule a second SL transmission of a second RAT (e.g., LTE). At block 1004, the BS may receive, from the UE, an indication of the one or more available resource pools (e.g., available resource pools 850). At block 1006, the BS may transmit an indication of a second resource pool for the first SL transmission, the second resource pool being selected from the one or more available resource pools.

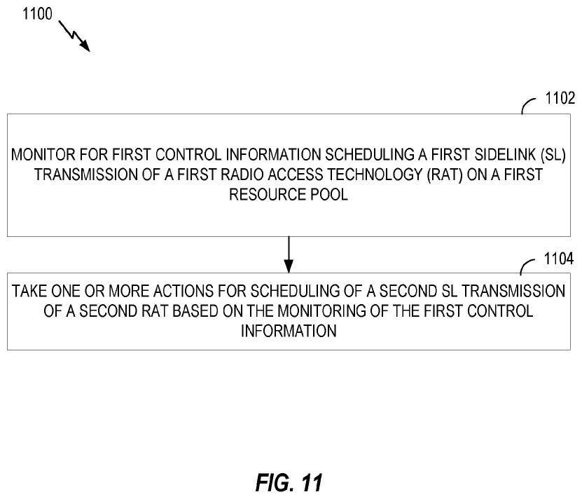

FIG. 11 is a flow diagram illustrating example operations 1100 for wireless communication, in accordance with certain aspects of the present disclosure. The operations 1100 may be performed, for example, by a first UE (e.g., the UE 120a in the wireless communication network 100). The operations 1100 may be complementary to the operations 1100 performed by the BS. The operations 1100 may be implemented as software components that are executed and run on one or more processors (e.g., controller/processor 280 of FIG. 2). Further, the transmission and reception of signals by the UE in operations 1100 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals. In some aspects, the operations 1100 may be executed based on instructions stored in memory, such as memory 282.

The operations 1100 begin, at block 1102, with the UE monitoring for first control information (e.g. DCI 902 from a BS 506 to a UE 502 or SCI 904 from a UE 502 to another UE 512 shown in FIG. 9A, or LTE SCI 702 of FIG. 7B) scheduling a first SL transmission of a first RAT (e.g., LTE) on a first resource pool. As an example, the UE may monitor for LTE SCI 702 that scheduled a SL transmission on resource pool 706) At block 1104, the UE may take one or more actions for scheduling of a second SL transmission of a second RAT (e.g., NR) based on the monitoring of the first control information.

In some aspects, taking the one or more actions may include transmitting, to a BS (e.g., BS 508), an indication of one or more resource pools (e.g., available resource pools 850 or 986) available for the second SL transmission, the one or more available resource pools being determined based on the monitoring of the first control information. The one or more actions may also include receiving an indication of a second resource pool (e.g., resource pool 988) for the second SL transmission from the BS in response to the transmission of the one or more available resource pools. The UE may perform the second SL transmission using the second resource pool. In some cases, transmitting the one or more available resource pools may include transmitting a bitmap (e.g., bitmap 851) indicating the one or more available resource pools to the BS. The UE may receive, from the BS, an indication (e.g. via a RRC message) of a mapping of each bit of the bitmap to one of the one or more available resource pools, which may be used for the indicating of the one or more available resource pools.

In some aspects, the UE may monitor for second control information (e.g., NR SCI 704) scheduling a third SL transmission of the second RAT on a second resource pool (e.g., resource pool 712), the one or more actions for scheduling of the second SL transmission being further based on the monitoring of the second control information. A RSRP threshold for detecting the first control information may be less than a RSRP threshold for detecting the second control information of the second RAT.

In some aspects, taking the one or more actions may include selecting a second resource pool for the second SL transmission, the first resource pool (e.g., resource pool 706 scheduled by the monitored LTE SCI 702) being precluded from consideration when selecting the second resource pool for the second SL transmission.

In some aspects, the UE may transmit, to a BS, a request to change a mode of operation of the UE allowing the UE to schedule SL resources independently from the BS. The request may be transmitted prior to the monitoring for the first control information. In some aspects, the UE may receive, from a BS, an indication of periodicity and duration for monitoring for the first control information.

In some aspects, taking the one or more actions may include determining whether the first resource pool is the same as a second resource pool scheduled for the second SL transmission based on the monitoring. Taking the one or more actions may also include transmitting an indication (e.g., via SCI 984 shown in FIG. 9B) to cancel the scheduled second resource pool for the second SL transmission based on the determination.

For the various operating modes described with respect to FIGS. 6, 7, and 8, semi-static NR/LTE resource pool coordination may be implemented to facilitate co-channel co-existence. For example, LTE and NR resource pools may be configured (e.g., preconfigured) without any overlapping, allowing NR UEs to coexist with LTE UEs on an LTE channel.

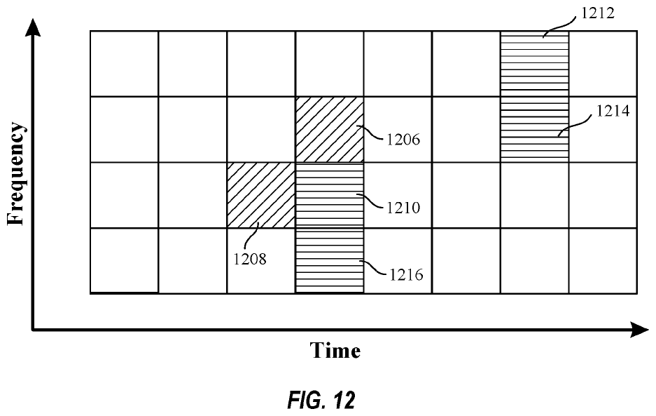

FIG. 12 illustrates candidate resource pools 1208, 1206 that may be scheduled for LTE and candidate resource pools 1210, 1212, 1216, 1214 that may be scheduled for NR, in accordance with certain aspects of the present disclosure. As shown, the candidate resource pools 1208, 1206 for LTE are non-overlapping with candidate resource pools 1210, 1212, 1216, 1214 for NR, such that NR communications do not interfere with LTE communications.

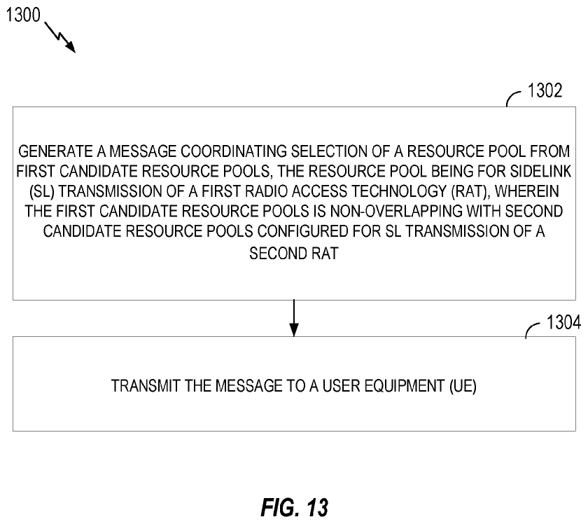

FIG. 13 is a flow diagram illustrating example operations 1300 for wireless communication, in accordance with certain aspects of the present disclosure. The operations 1300 may be performed, for example, by a network entity and/or a BS (e.g., the BS 110a in the wireless communication network 100). The operations 1300 may be implemented as software components that are executed and run on one or more processors (e.g., controller/processor 240 of FIG. 2). Further, the transmission and reception of signals by the BS in operations 1300 may be enabled, for example, by one or more antennas (e.g., antennas 234 of FIG. 2). In certain aspects, the BS's transmission and/or reception of signals may be implemented via a bus interface of one or more processors (e.g., controller/processor 240) obtaining and/or outputting signals.

The operations 1300 may begin, at block 1302, with the BS generating a message coordinating selection of a resource pool from candidate resource pools (e.g., candidate resource pools 1210, 1212, 1214, 1216), the resource pool being for SL transmission of a first RAT (e.g., NR). The candidate resource pools may be non-overlapping with other candidate resource pools (e.g., candidate resource pools 1206, 1208) configured for SL transmission of a second RAT (e.g., LTE). In some aspects, the message coordinating the selection may indicate the candidate resource pools to be used by the UE for the selection of the resource pool. to the UE. The block 1304, the BS may transmit the message to a UE.

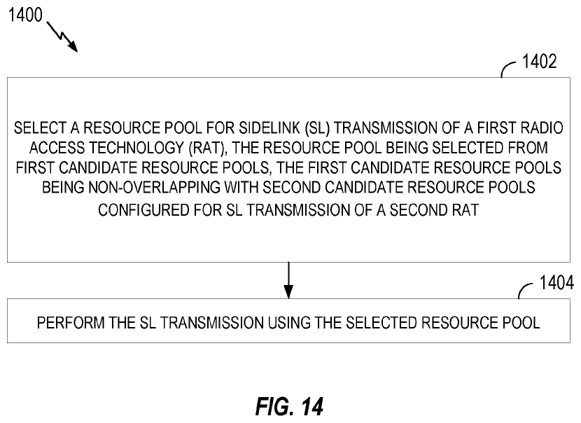

FIG. 14 is a flow diagram illustrating example operations 1400 for wireless communication, in accordance with certain aspects of the present disclosure. The operations 1400 may be performed, for example, by a first UE (e.g., the UE 120a in the wireless communication network 100). The operations 1400 may be complementary to the operations 700 performed by the BS. The operations 1400 may be implemented as software components that are executed and run on one or more processors (e.g., controller/processor 280 of FIG. 2). Further, the transmission and reception of signals by the UE in operations 1400 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1400 begin, at block 1402, with the UE selecting a resource pool for SL transmission of a first RAT (e.g., NR), the resource pool being selected from candidate resource pools (e.g., candidate resource pools 1210, 1212, 1214, 1216), the first candidate resource pools being non-overlapping with other candidate resource pools (e.g., candidate resource pools 1206, 1208) configured for SL transmission of a second RAT (e.g., LTE). In some aspects, the UE may receive, from a BS, a message indicating the first candidate resource pools. In some aspects, selecting the resource pool may include receiving, from the BS, a message indicating the resource pool. At block 1404, the UE may perform the SL transmission using the selected resource pool.

### Example Wireless Communication Devices

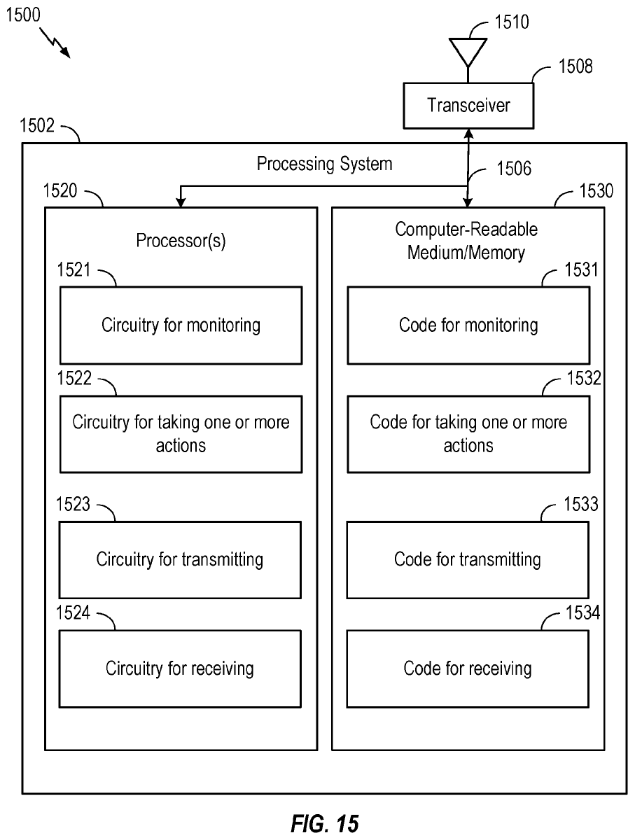

FIG. 15 depicts an example communications device 1500 that includes various components operable, configured, or adapted to perform operations for the techniques disclosed herein, such as the operations depicted and described with respect to FIGS. 11 and 14. In some examples, communication device 1500 may be a user equipment 104 as described, for example with respect to FIGS. 1 and 2.

Communications device 1500 includes a processing system 1502 coupled to a transceiver 1508 (e.g., a transmitter and/or a receiver). Transceiver 1508 is configured to transmit (or send) and receive signals for the communications device 1500 via an antenna 1510, such as the various signals as described herein. Processing system 1502 may be configured to perform processing functions for communications device 1500, including processing signals received and/or to be transmitted by communications device 1500.

Processing system 1502 includes one or more processors 1520 coupled to a computer-readable medium/memory 1530 via a bus 1506. In certain aspects, computer-readable medium/memory 1530 is configured to store instructions (e.g., computer-executable code) that when executed by the one or more processors 1520, cause the one or more processors 1520 to perform the operations illustrated in FIGS. 11 and 14, or other operations for performing the various techniques discussed herein for coordination of carrier selection between long term evolution (LTE) and new radio (NR) sidelink (SL).

In the depicted example, computer-readable medium/memory 1530 stores code 1531 (e.g., an example of means for) for monitoring; code 1532 (e.g., an example of means for) for taking one or more actions; code 1533 (e.g., an example of means for) for transmitting; and code 1534 (e.g., an example of means for) for receiving.

In the depicted example, the one or more processors 1520 include circuitry configured to implement the code stored in the computer-readable medium/memory 1530, including circuitry 1521 (e.g., an example of means for) for monitoring; circuitry 1522 (e.g., an example of means for) for taking one or more actions; circuitry 1523 (e.g., an example of means for) for transmitting; and circuitry 1524 (e.g., an example of means for) for receiving.

Various components of communications device 1500 may provide means for performing the methods described herein.

In some examples, means for transmitting or sending (or means for outputting for transmission) may include the transceivers 254 and/or antenna(s) 252 of the user equipment 104 illustrated in FIG. 2 and/or transceiver 1508 and antenna 1510 of the communication device 1500 in FIG. 15.

In some examples, means for receiving (or means for obtaining) may include the transceivers 254 and/or antenna(s) 252 of the user equipment 104 illustrated in FIG. 2 and/or transceiver 1508 and antenna 1510 of the communication device 1500 in FIG. 15.

In some examples, means for monitoring, means for taking one or more actions, means for transmitting, and/or means for receiving may include various processing system components, such as: the one or more processors 1520 in FIG. 15, or aspects of the user equipment 104 depicted in FIG. 2, including receive processor 258, transmit processor 264, TX MIMO processor 266, and/or controller/processor 280 (including SL component 281).

Notably, FIG. 15 is just use example, and many other examples and configurations of communication device 1500 are possible.

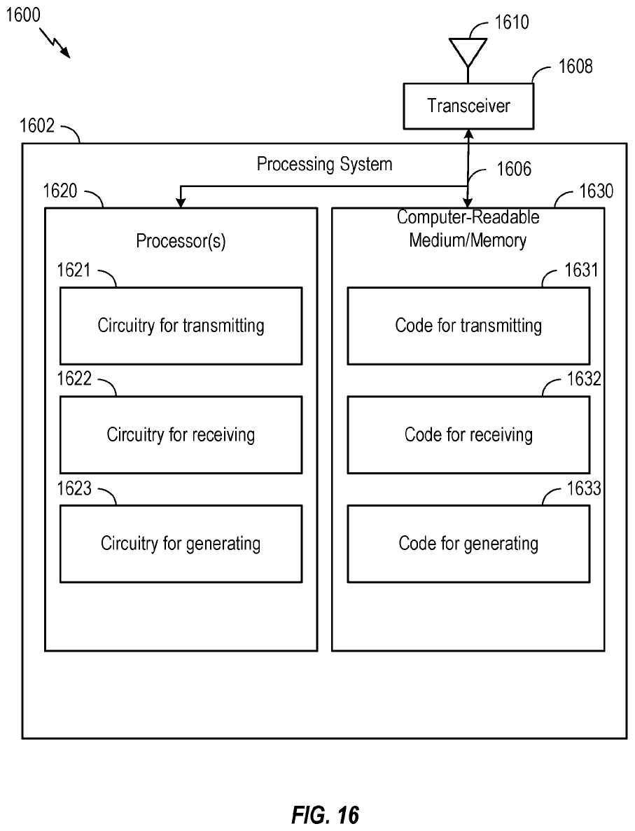

FIG. 16 depicts an example communications device 1600 that includes various components operable, configured, or adapted to perform operations for the techniques disclosed herein, such as the operations depicted and described with respect to FIGS. 10 and 13. In some examples, communication device 1600 may be a base station 102 as described, for example with respect to FIGS. 1 and 2.

Communications device 1600 includes a processing system 1602 coupled to a transceiver 1608 (e.g., a transmitter and/or a receiver). Transceiver 1608 is configured to transmit (or send) and receive signals for the communications device 1600 via an antenna 1610, such as the various signals as described herein. Processing system 1602 may be configured to perform processing functions for communications device 1600, including processing signals received and/or to be transmitted by communications device 1600.

Processing system 1602 includes one or more processors 1620 coupled to a computer-readable medium/memory 1630 via a bus 1606. In certain aspects, computer-readable medium/memory 1630 is configured to store instructions (e.g., computer-executable code) that when executed by the one or more processors 1620, cause the one or more processors 1620 to perform the operations illustrated in FIGS. 10 and 13, or other operations for performing the various techniques discussed herein for coordination of carrier selection between LTE and NR SL.

In the depicted example, computer-readable medium/memory 1630 stores code 1631 (e.g., an example of means for) for transmitting; code 1632 (e.g., an example of means for) for receiving; and code 1633 (e.g., an example of means for) for generating.

In the depicted example, the one or more processors 1620 include circuitry configured to implement the code stored in the computer-readable medium/memory 1630, including circuitry 1621 for transmitting; circuitry 1622 for receiving; and circuitry 1623 for generating.

Various components of communications device 1600 may provide means for performing the methods described herein, including with respect to FIGS. 8-18.

In some examples, means for transmitting or sending (or means for outputting for transmission) may include the transceivers 232 and/or antenna(s) 234 of the base station 102 illustrated in FIG. 2 and/or transceiver 1608 and antenna 1610 of the communication device 1600 in FIG. 16.

In some examples, means for receiving (or means for obtaining) may include the transceivers 232 and/or antenna(s) 234 of the base station illustrated in FIG. 2 and/or transceiver 1608 and antenna 1610 of the communication device 1600 in FIG. 16.

In some examples, means for generating may include various processing system components, such as: the one or more processors 1620 in FIG. 16, or aspects of the base station 102 depicted in FIG. 2, including receive processor 238, transmit processor 220, TX MIMO processor 230, and/or controller/processor 240 (including carrier indication component 241).

Notably, FIG. 16 is just use example, and many other examples and configurations of communication device 1600 are possible.

The transceiver 1508 or 1608 may provide a means for receiving or transmitting information such as packets, user data, or control information associated with various information channels (e.g., control channels, data channels, and information related to feedback, etc.). Information may be passed on to other components of the device 1500 or 1600. The transceiver 1508 or 1608 may be an example of aspects of the transceiver 254 described with reference to FIG. 2. The antenna 1510 or 1610 may correspond to a single antenna or a set of antennas. The transceiver 1508 or 1608 may provide means for transmitting signals generated by other components of the device 1500 or 1600.

The SL component 198 or 199 may support wireless communication in accordance with examples as disclosed herein.

The SL component 198 or 199 may be an example of means for performing various aspects described herein. The SL component 198 or 199, or its sub-components, may be implemented in hardware (e.g., in uplink resource management circuitry). The circuitry may comprise of processor, DSP, an ASIC, a FPGA or other programmable logic device, discrete gate or transistor logic, discrete hardware components, or any combination thereof designed to perform the functions described in the present disclosure.

In another implementation, the SL component 198 or 199, or its sub-components, may be implemented in code (e.g., as configuration management software or firmware) executed by a processor, or any combination thereof. If implemented in code executed by a processor, the functions of the SL component 198 or 199, or its sub-components may be executed by a general-purpose processor, a DSP, an ASIC, a FPGA or other programmable logic device.

In some examples, the SL component 198 or 199 may be configured to perform various operations (e.g., receiving, determining, transmitting) using or otherwise in cooperation with the transceiver 1508, 1608.

The SL component 198 or 199, or its sub-components, may be physically located at various positions, including being distributed such that portions of functions are implemented at different physical locations by one or more physical components. In some examples, the SL component 198 or 199, or its sub-components, may be a separate and distinct component in accordance with various aspects of the present disclosure. In some examples, the SL component 198 or 199, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

### EXAMPLE CLAUSES

Implementation examples are described in the following numbered clauses:

Clause 1. A method for wireless communication by a user-equipment (UE), comprising: monitoring for first control information scheduling a first sidelink (SL) transmission of a first radio access technology (RAT) on a first resource pool; and taking one or more actions for scheduling of a second SL transmission of a second RAT based on the monitoring of the first control information, wherein the first RAT is different than the second RAT.

Clause 2. The method of clause 1, further comprising monitoring for second control information scheduling a third SL transmission of the second RAT on a second resource pool, the one or more actions for scheduling of the second SL transmission being further based on the monitoring of the second control information.

Clause 3. The method of clause 2, wherein a reference signal receive power (RSRP) threshold for detecting the first control information is less than a RSRP threshold for detecting the second control information of the second RAT.

Clause 4. The method of any one of clauses 1-3, wherein taking the one or more actions comprises selecting a second resource pool for the second SL transmission, the first resource pool being precluded from consideration when selecting the second resource pool for the second SL transmission.

Clause 5. The method of any one of clauses 1-4, further comprising transmitting, to a base station (BS), a request to change a mode of operation of the UE allowing the UE to schedule SL resources independently from the BS, the request being transmitted prior to the monitoring for the first control information.

Clause 6. The method of any one of clauses 1-5, wherein: taking the one or more actions comprises transmitting, to a BS, an indication of one or more resource pools available for the second SL transmission, the one or more available resource pools being determined based on the monitoring of the first control information, and receiving an indication of a second resource pool for the second SL transmission from the BS in response to the transmission of the one or more available resource pools; and the method further comprises performing the second SL transmission using the second resource pool.

Clause 7. The method of clause 6, wherein transmitting the one or more available resource pools comprises transmitting a bitmap indicating the one or more available resource pools.

Clause 8. The method of clause 7, further comprising receiving, from the BS, an indication of a mapping of each bit of the bitmap to one of the one or more available resource pools.

Clause 9. The method of clause 8, wherein the indication of the mapping is received via a radio resource control (RRC) message.

Clause 10. The method of any one of clauses 1-9, further comprising receiving, from a BS, an indication of periodicity and duration for monitoring for the first control information.

Clause 11. The method of any one of clauses 1-10, wherein the first control information comprises downlink control information (DCI).

Clause 12. The method of any one of clauses 1-11, wherein the first control information comprises sidelink control information (SCI).

Clause 13. The method of any one of clauses 1-12, wherein taking the one or more actions comprises: determining whether the first resource pool is the same as a second resource pool scheduled for the second SL transmission based on the monitoring; and transmitting an indication to cancel the scheduled second resource pool for the second SL transmission based on the determination.

Clause 14. The method of any one of clauses 1-13, wherein the first RAT comprises new radio (NR), and wherein the second RAT comprises long-term evolution (LTE).

Clause 15. A method for wireless communication by a base station (BS), comprising: transmitting, to a user equipment (UE), a configuration for the UE to monitor first control information for selection of one or more available resource pools for a first sidelink (SL) transmission of a first radio access technology (RAT), wherein the first control information schedules a second SL transmission of a second RAT, wherein the first RAT is different than the second RAT; receiving, from the UE, an indication of the one or more available resource pools; and transmitting an indication of a second resource pool for the first SL transmission, the second resource pool being selected from the one or more available resource pools.

Clause 16. The method of clause 15, wherein transmitting the configuration comprises transmitting a configuration for the UE to monitor second control information for the selection of the one or more available resource pools, the second control information scheduling a third SL transmission of the first RAT.

Clause 17. The method of any one of clauses 15-16, wherein receiving the one or more available resource pools comprises receiving a bitmap indicating the one or more available resource pools.

Clause 18. The method of clause 17, further comprising transmitting, to the UE, an indication of a mapping of each bit of the bitmap to one of the one or more available resource pools.

Clause 19. The method of clause 18, wherein the indication of the mapping is transmitted via a radio resource control (RRC) message.

Clause 20. The method of any one of clauses 15-19, wherein the first RAT comprises new radio (NR), and wherein the second RAT comprises long-term evolution (LTE).

Clause 21. A method for wireless communication by a user-equipment (UE), comprising: selecting a resource pool for sidelink (SL) transmission of a first radio access technology (RAT), the resource pool being selected from first candidate resource pools, the first candidate resource pools being non-overlapping with second candidate resource pools configured for SL transmission of a second RAT, wherein the first RAT is different than the second RAT; and performing the SL transmission using the selected resource pool.

Clause 22. The method of clause 21, further comprising receiving, from a base station (BS), a message indicating the first candidate resource pools.

Clause 23. The method of any one of clauses 21-22, wherein selecting the resource pool comprises receiving, from the BS, a message indicating the resource pool.

Clause 24. The method of any one of clauses 21-23, wherein the first RAT comprises new radio (NR), and wherein the second RAT comprises long-term evolution (LTE).

Clause 25. A method for wireless communication by a base station (BS), comprising: generating a message coordinating selection of a resource pool from first candidate resource pools, the resource pool being for sidelink (SL) transmission of a first radio access technology (RAT), wherein the first candidate resource pools is non-overlapping with second candidate resource pools configured for SL transmission of a second RAT, wherein the first RAT is different than the second RAT; and transmitting the message to a user equipment (UE).

Clause 26. The method of clause 25, wherein the message coordinating the selection comprises a message indicating the first candidate resource pools to be used by the UE for the selection of the resource pool.

Clause 27. The method of any one of clauses 25-26, wherein the message coordinating the selection comprises a message indicating the resource pool to the UE.

Clause 28. The method of any one of clauses 25-27, wherein the first RAT comprises new radio (NR), and wherein the second RAT comprises long-term evolution (LTE).

Clause 29: An apparatus, comprising: a memory and one or more processors coupled to the memory, the memory and the one or more processors being configured to perform a method in accordance with any one of Clauses 1-28.

Clause 30: An apparatus, comprising means for performing a method in accordance with any one of Clauses 1-28.

Clause 31: A non-transitory computer-readable medium comprising executable instructions that, when executed by one or more processors of an apparatus, cause the apparatus to perform a method in accordance with any one of Clauses 1-28.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS or a home BS.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). Base stations 102 configured for 5G (e.g., 5G NR or Next Generation RAN (NG-RAN)) may interface with core network 190 through second backhaul links 184. Base stations 102 may communicate directly or indirectly (e.g., through the EPC 160 or core network 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station. The gNB 180 may also communicate with one or more UEs 104 via a beam formed connection 182 (e.g., via beams 182′ and 182″).

The communication links 130 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink (SL) channels, such as a physical SL broadcast channel (PSBCH), a physical SL discovery channel (PSDCH), a physical SL shared channel (PSSCH), and a physical SL control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

Core network 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and core network 190. Generally, AMF 192 provides QoS flow and session management.

All user Internet protocol (IP) packets are transferred through UPF 195, which is connected to the IP Services 197, and which provides UE IP address allocation as well as other functions for core network 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

### ADDITIONAL CONSIDERATIONS

The preceding description provides examples of NR and LTE sidelink co-channel co-existence in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication by a user-equipment (UE), comprising:
one or more processors; and
a memory, the memory and the one or more processors being configured to:
monitor for first control information scheduling a first sidelink (SL) transmission of a first radio access technology (RAT) on a first resource pool; and
take one or more actions for scheduling of a second SL transmission of a second RAT based on the monitoring of the first control information, wherein the first RAT is different than the second RAT.

2. The apparatus of claim 1, the memory and the one or more processors are further configured to:
monitor for second control information scheduling a third SL transmission of the second RAT on a second resource pool; and
take the one or more actions for scheduling of the second SL transmission based on the monitoring of the second control information.

3. The apparatus of claim 2, wherein a reference signal receive power (RSRP) threshold for detection of the first control information is less than an RSRP threshold for detection of the second control information of the second RAT.

4. The apparatus of claim 1, wherein in configuring to take the one or more actions, the memory and the processor are configured to select by a second resource pool for the second SL transmission, the first resource pool being precluded from consideration when selecting the second resource pool for the second SL transmission.

5. The apparatus of claim 1, wherein the memory and the one or more processors are further configured to transmit, to a base station (BS), a request to change a mode of operation of the UE allowing the UE to schedule SL resources independently from the BS, the request being transmitted prior to the monitoring for the first control information.

6. The apparatus of claim 1, wherein:
in configuring to take the one or more actions, the memory and the one or more processors are configured to:
transmit, to a BS, an indication of one or more resource pools available for the second SL transmission, the one or more resource pools being determined based on the monitoring of the first control information, and
receive an indication of a second resource pool for the second SL transmission from the BS in response to the transmission of the one or more resource pools; and
the memory and the one or more processors are further configured to perform the second SL transmission using the second resource pool.

7. The apparatus of claim 6, wherein in configuring to transmit the indication of the one or more resource pools, the memory and the one or more processors are configured to transmit a bitmap indicating the one or more resource pools.

8. The apparatus of claim 7, wherein the memory and the one or more processors are further configured to receive, from the BS, an indication of a mapping of each bit of the bitmap to one of the one or more resource pools.

9. The apparatus of claim 8, wherein the indication of the mapping is received via a radio resource control (RRC) message.

10. The apparatus of claim 1, wherein the memory and the one or more processors are further configured to receive, from a BS, an indication of periodicity and duration for monitoring for the first control information.

11. The apparatus of claim 1, wherein the first control information comprises downlink control information (DCI).

12. The apparatus of claim 1, wherein the first control information comprises sidelink control information (SCI).

13. The apparatus of claim 1, wherein in configuring to take the one or more actions, the memory and the one or more processors are configured to:
determine whether the first resource pool is the same as a second resource pool scheduled for the second SL transmission based on the monitoring; and
transmit an indication to cancel the second resource pool for the second SL transmission based on the determination.

14. The apparatus of claim 1, wherein the first RAT comprises new radio (NR), and wherein the second RAT comprises long-term evolution (LTE).

15. The apparatus of claim 1, further comprising at least one antenna, wherein the memory and the one or more processors are configured to monitor for the first control information via the at least one antenna.

16. An apparatus for wireless communication by a base station (BS), comprising:
a memory; and
one or more processors coupled to the memory, the memory and the one or more processors being configured to:
transmit, to a user equipment (UE), a configuration for the UE to monitor first control information for selection of one or more available resource pools for a first sidelink (SL) transmission of a first radio access technology (RAT), wherein the first control information schedules a second SL transmission of a second RAT, and wherein the first RAT is different than the second RAT;
receive, from the UE, an indication of the one or more available resource pools; and
transmit an indication of a second resource pool for the first SL transmission, the second resource pool being selected from the one or more available resource pools.

17. The apparatus of claim 16, wherein in configuring to transmit the configuration, the memory and the one or more processors are configured to transmit the configuration for the UE to monitor second control information for the selection of the one or more available resource pools, the second control information scheduling a third SL transmission of the first RAT.

18. The apparatus of claim 16, wherein the memory and the one or more processors are configured to receive the one or more available resource pools by receiving a bitmap indicating the one or more available resource pools.

19. The apparatus of claim 18, the memory and the one or more processors are further configured to transmit, to the UE, an indication of a mapping of each bit of the bitmap to one of the one or more available resource pools.

20. The apparatus of claim 19, wherein the indication of the mapping is transmitted via a radio resource control (RRC) message.

21. The apparatus of claim 16, wherein the first RAT comprises new radio (NR), and wherein the second RAT comprises long-term evolution (LTE).

22. The apparatus of claim 16, further comprising at least one antenna, wherein the memory and the one or more processors are configured to transmit the configuration via the at least one antenna.

23. An apparatus for wireless communication by a user-equipment (UE), comprising:
a memory; and
one or more processors coupled to the memory, the memory and the one or more processors being configured to:
select a resource pool for sidelink (SL) transmission of a first radio access technology (RAT), the resource pool being selected from candidate resource pools, the candidate resource pools being non-overlapping with other candidate resource pools configured for SL transmission of a second RAT, wherein the first RAT is different than the second RAT; and
perform the SL transmission using the selected resource pool.

24. The apparatus of claim 23, wherein the memory and the one or more processors are further configured to receive, from a base station (BS), a message indicating the candidate resource pools.

25. The apparatus of claim 23, wherein the memory and the one or more processors are configured to select the resource pool by receiving, from the BS, a message indicating the resource pool.

26. The apparatus of claim 23, wherein the first RAT comprises new radio (NR), and wherein the second RAT comprises long-term evolution (LTE).

27. An apparatus for wireless communication by a base station (BS), comprising:
a memory; and
one or more processors coupled to the memory, the memory and the one or more processors being configured to:
generate a message coordinating selection of a resource pool from candidate resource pools, the resource pool being for sidelink (SL) transmission of a first radio access technology (RAT), wherein the candidate resource pools is non-overlapping with other candidate resource pools configured for SL transmission of a second RAT, wherein the first RAT is different than the second RAT; and
transmit the message to a user equipment (UE).

28. The apparatus of claim 27, wherein the message coordinating the selection comprises a message indicating the candidate resource pools to be used by the UE for the selection of the resource pool.

29. The apparatus of claim 27, wherein the message coordinating the selection comprises a message indicating the resource pool to the UE.

30. The apparatus of claim 27, wherein the first RAT comprises new radio (NR), and wherein the second RAT comprises long-term evolution (LTE).
